(19) United States
(12) Patent Application Publication
(10) Pub. No.: US 2016/0149200 A1
(43) Pub. Date: May 26, 2016

(54) Battery Lock

(71) Applicant: Edgar Eduardo VERDU, Provincia de Cordoba (AR)

(72) Inventor: Edgar Eduardo VERDU, Provincia de Cordoba (AR)

(21) Appl. No.: 14/924,764

(22) Filed: Oct. 28, 2015

Related U.S. Application Data
(60) Provisional application No. 62/082,318, filed on Nov. 20, 2014.

(51) Int. Cl. H01M 2/34; H01M 2/10

(52) U.S. Cl. CPC H01M 2/341; H01M 2/1077; H01M 2/1094; H01M 2220/10

(57) ABSTRACT

The present invention relates to a batteries lock kit to prevent an unauthorized removal of pre-existent batteries from a cabinet of a communication tower. The kit includes: a package container including: a metallic tray adapted to be placed inside the cabinet; a resin; a hardener agent; plastic supports; a pair of terminal covertures; at least one metal band; the metallic tray is adapted to support the pre-existent batteries.

### CROSS-REFERENCE TO RELATED APPLICATIONS

This application claims the benefit of priority to U.S. Provisional Application No. 62/082,318, filed Nov. 20, 2014, the contents of which are incorporated herein by reference.

### FIELD OF THE INVENTION

The present invention refers to a batteries lock kit. More specifically, the present invention refers to a batteries lock kit that prevents the unauthorized removal of batteries from the base of a communication tower. In addition, the present invention relates to a method for using the batteries lock kit of the present invention to in-situ secure the batteries bank on the base of a communication tower or similar facilities.

### BACKGROUND OF THE INVENTION

It is a common occurrence, the vandalism and the theft at the communication towers to steal metals, such as cooper. Unfortunately, a new trend is being developed: the theft of the batteries at the base of the communication tower. Stealing cell tower batteries, at the towers sites, affects not only because of the damage caused to the tower station (cabinets-wiring-padlocks-wiring cuts-operation cost of the cell-owner, etc.), but also because of the possible downtime of the service, which generates: high reparation costs of caused damage, fines because of the lack of service, longer cuts and more serious, if damage is caused to a node, can generate the collapse of multiple sites, and/or alarm activation and increasing complaints.

A solution to this problem may be the implementation of electronic key access mechanisms by using pin pads, electronic keys, or other devices with RFID or biometric features. Another solution may be the installation of surveillance cameras with access control as well as motion control. Unfortunately, the above identified solutions require the use of sophisticated equipment that significantly increases the maintenance cost of the communication towers.

There is a need for an easy to install system, that is able to reduce the minimum of incidents of batteries vandalism in the communication towers, ensuring a normal operation of the site.

### SUMMARY OF THE INVENTION

The present invention relates to a batteries lock kit to prevent an unauthorized removal of pre-existent batteries from a cabinet of a communication tower, the kit includes: a package container including: a metallic tray adapted to be placed inside the cabinet; a resin; a hardener agent; plastic supports; a pair of terminal covertures; at least one metal band; emission hose; the metallic tray is adapted to support the pre-existent batteries.

In addition, the present invention relates to a method for preventing an unauthorized removal of pre-existent batteries from a cabinet of a communication tower, the method comprising the steps of: providing the kit according to claim 1; disassembling the cabinet; placing the metallic tray inside the disassembled cabinet, the metallic tray including side walls; placing the pre-existing batteries of the cabinet inside the metallic tray; placing covers on electrical terminals of the batteries; securing at least one metal band to side walls of the metallic tray; connecting the emission hose to each one of the batteries and then to electrical terminals on the battery; pouring a mixture containing the resin and the hardening agent over the batteries inside the metallic tray; and reassembling the cabinet.

### BRIEF DESCRIPTION OF THE FIGURES

For further clarity and understanding of the present invention, it is shown in different figures in which it is represented according to the preferred embodiments, only as an example:

FIGS. 1a-1b show a detailed view of the components of the in-situ batteries lock kit according to an embodiment of the present invention;

FIGS. 2a-2d show different views of the different types of commercially available cabinet, normally located on the station at the communication towers;

FIGS. 3a-3b show that the metallic tray is designed to receive the pre-existing batteries of the cabinet located on the station of the communication tower;

FIGS. 4a-4c show different steps for disassembling one of the types of pre-existing cabinets commonly found on the station of the communication tower;

FIGS. 5a-5c show the step of cutting the handles of the batteries placed inside the metallic housing;

FIG. 6 shows the step of connecting the emission hoses to each battery;

FIG. 7 shows the steps placing the covers on the terminals and connecting the emission hoses to the terminals;

FIG. 8 shows the step of securing at least one metal band to side walls of the metallic tray to prevent the bending of the metallic tray or spills;

FIG. 9 shows the step of pouring a mixture containing the resin and the hardening agent over the batteries inside the metallic housing;

FIG. 10 shows the user re-assembling the cabinet; and

FIGS. 11-14 show graphs with the thermo graphics results of the curing of the resin taken at different times of the curing process.

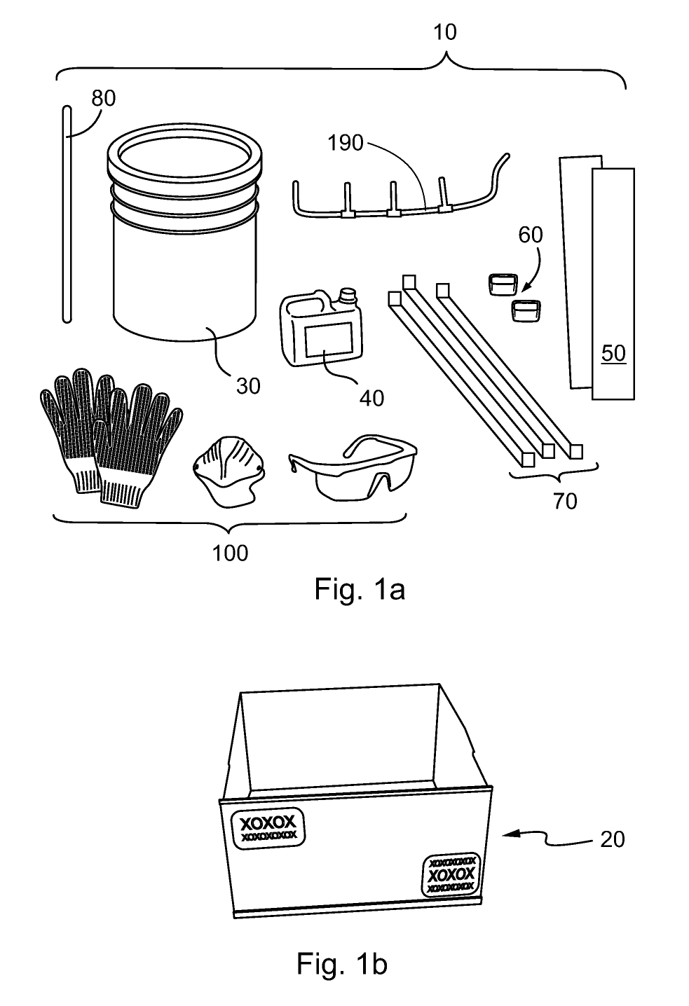

### DETAILED DESCRIPTION OF THE INVENTION

The present invention refers to a batteries lock kit 10 to the unauthorized removal of batteries from the base of a communication tower. The batteries lock kit 10 includes: a package (not shown) including a metallic tray 20, a resin 30, a hardener agent 40, plastic supports 50, a pair of terminal covertures 60, metal bands 70, and emission hoses 190. In an embodiment, the batteries lock kit 10 may optionally include a stirrer 80, a disposable bag (not shown), and a safety kit 100 including safety glasses, gloves and a safety mask.

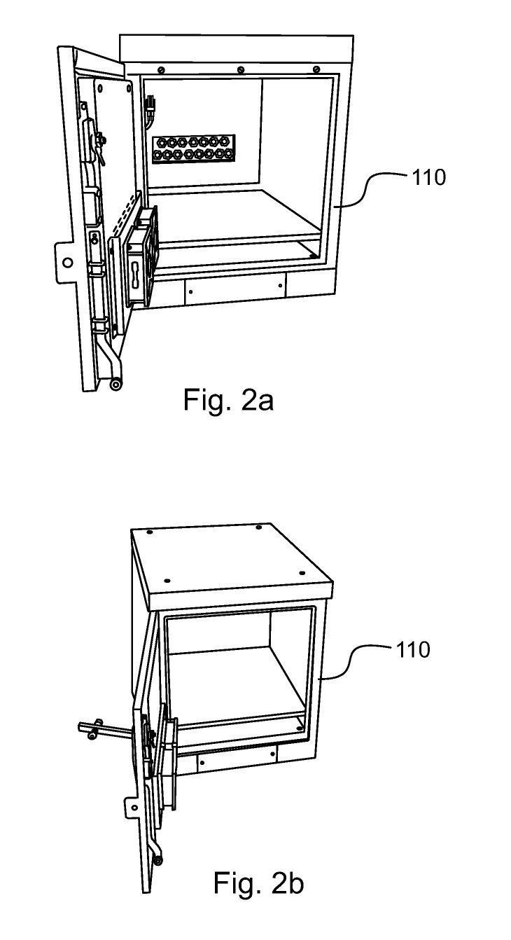

The batteries lock kit 10 is adapted to be placed inside a commercially available cabinet 110 that is normally located on the station on the communication tower. FIGS. 2a-2d show some of the different types of the commercially available cabinet 110.

### Metallic Tray

The metallic tray 20 may be made of a metal, for example, aluminum, steel, stainless steel, tin, or any material that dissipate the heat produced during the chemical reaction of the resin and hardener agent.

The metallic tray 20 may fit inside the cabinet 110. The size and shape of the metallic tray 20 may depend on the size and shape of the cabinet 110. For example, the metallic tray 20 may have a height of 0.530 metros, a width of 0.530 metros, and a depth of 0.570 metros. Each metallic tray 20 may be specifically designed to meet the user requirements.

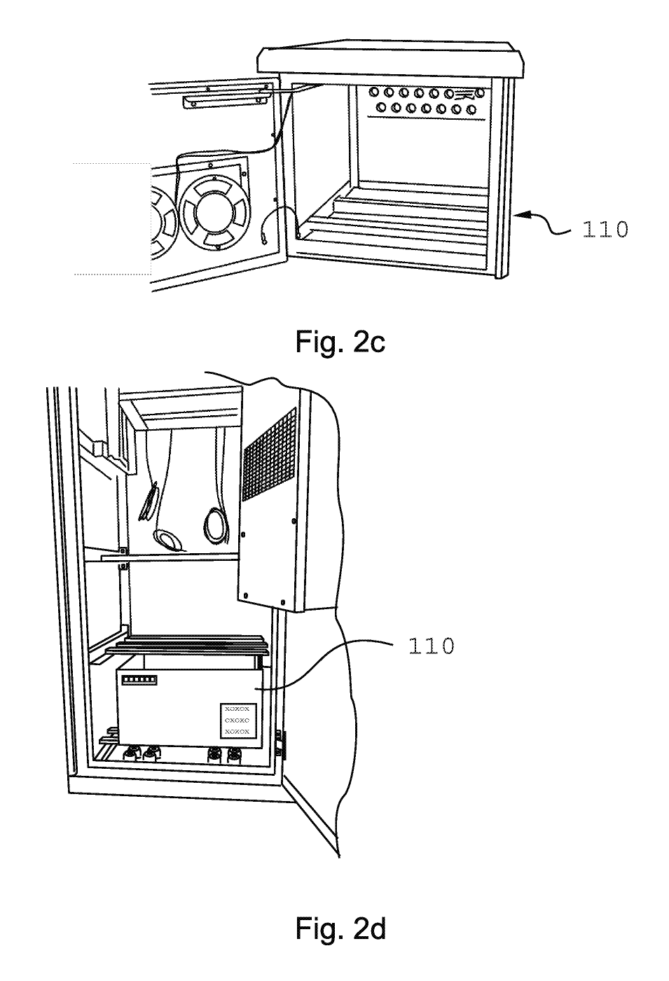

As can be seen on FIGS. 3a-3b, the metallic tray 20 is designed to receive the pre-existing batteries 120 of the cabinet 110 located on the station of the communication tower.

The batteries 120 are placed inside the metallic tray 20, one next to the other, by leaving a space 125 between the batteries 120 and the border 25 of the metallic tray 20.

### Resin

The resin 30 may be of higher molecular weight polymers. In some embodiments, the resin may be, for example, an epoxy resin. It is important that the resin 30 have a reaction temperature equal or less than 50° C. The resin is used in amount of 7 liters to 12 liters.

Epoxy resins are an important class of polymeric materials, characterized by the presence of more than one epoxy-ring. The epoxy resins are converted into cured epoxy resins, which are solid, infusible and insoluble 3-dimensional networks, with the help of hardener agents, which can undergo chemical reactions with the epoxy rings of the epoxy resin.

In some embodiments, the resin is a modified biphenol A epoxy (PL-302), such as the one sold by Prodyser SA. The modified biphenol A epoxy contains at least two epoxide groups.

### Hardener Agent

The hardener agent 40 is combined with the resin 30 to form a composition that is poured out into the batteries 120 that have been placed inside the metallic tray 20. The hardener agent 40 acts as a curing agent for the resin 30. The hardener agent 40 may provide cured resin products that exhibit fast cure speed, especially at ambient temperatures, and improved physical properties.

The hardener agent 40 may be selected depending on the resin 30. The hardener agent 40 may be, for example, an aliphatic polyamine that offers a short pot-life and cures in minutes with the resin. In some embodiments, the hardener may be, for example, a polyethyleneamines such as diethylenetriamine (DETA), triethylenetetramine (TETA). The hardener agent 40 may be selected depending on weather of the region where the kit is installed. The polyethyleneamines react very rapidly with the epoxy resin.

The triethylenetetramine accelerates the curing of the epoxy reaction. These curing properties may be attributed to the presence of the tertiary amines which act as a catalyst in the reaction between primary and secondary amines with epoxides. The curing time, gel time, setting time or time of hardening usually all refer to the time required for a resin to effectively solidify at the molding temperature.

The amount of hardener agent 40 used to cure the resin 30 may depend on the amount of resin 30. The hardener agent 40 is used in the amount of 0.1 liters to 1 liters.

### Plastic Supports

The plastic support 50 may be placed on the floor of the metallic tray 20. The plastic supports 50 may be used to rise the batteries 120 from the floor of the housing, thus the mixture of the resin 30 and hardener agent 40 spreads under the batteries to completely enclosed the batteries 120 with the mixture.

The plastic support 50 may have any shape or size. The plastic support may be made of a thermosetting plastic, for example, melamine, or plastic, or wood.

### Terminal Covertures

The terminal covertures 60 are placed on the left and right terminal 160 of the batteries block 170 to protect the terminals 160 from being covered with the cured resin. The terminal covertures 60 may be made of plastic or any other material that does not melt easy with heat and that is not a conductor. The terminal covertures 60 may have a shape similar to the shape of the base (not shown) of the terminals of the batteries.

### Metal Bands

The metal bands 70 may be secured to the side walls 25 of the metallic tray 20 to prevent the bending of the metallic tray and to prevent any possible spills of the cured resin to the outside of the tray 20. The number of metal bands 70 may depend on the size of the metallic tray 20. The size of the metal bands 70 may depend on the size of the metallic tray 20. The metal bands 70 may be placed transversally and/or longitudinal with regards to the walls 25 of the metallic tray 20.

The metal bands 70 may be made of steel, aluminum, reinforced steel, or composite. In some embodiments, the metal bands 70 are made of a none metallic material such as wood, or plastic.

### Emission Hoses

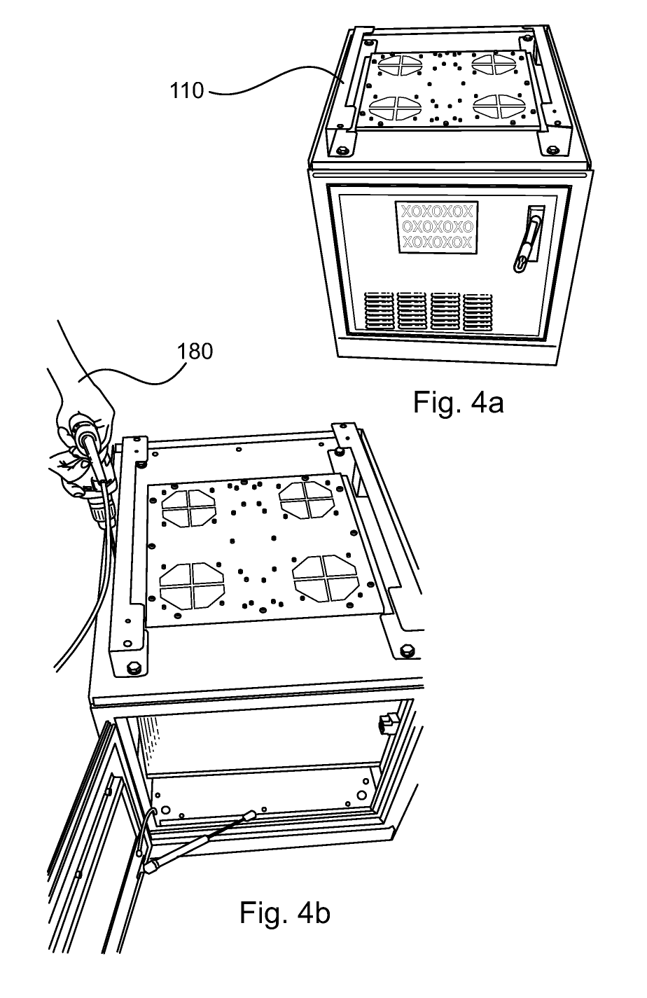

The emission hose 190 are connected to each battery to and then to the terminals 160. See FIG. 6. The emission hoses 190 may be made of a flexible material such as plastic.

### Optional Elements

A stirrer 80, a safety disposable bag (not shown), and a safety kit 100 including safety glasses, gloves and a safety mask. All of these elements are standard elements normally found in stores.

### HOW TO USE THE INVENTION

It is important that the kit 10 is assembled in-situ inside the pre-existent cabinet 110, since after the assembling the system is too heavy to move around and bulky to pass through the cabinet door.

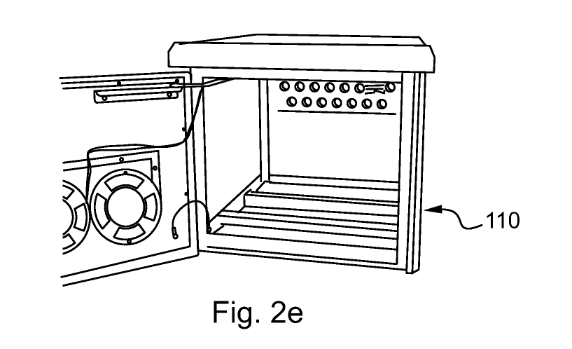

As can be seen from FIGS. 4a-4c, the user 180 may have to disassemble a standard cabinet 110 found on the pre-existent station of the communication tower. A person skilled in the art will understand that the disassembly of the different types of cabinets 110 will require a different approach.

The metallic tray 20 is placed inside the disassembled cabinet 110. The plastic supports 50 may be optionally placed at the bottom of the metallic tray 20. The batteries 120 are introduced inside the metallic tray 20 in direct contact with the bottom part or optionally on top of the plastic support 50. See FIG. 3a-3b.

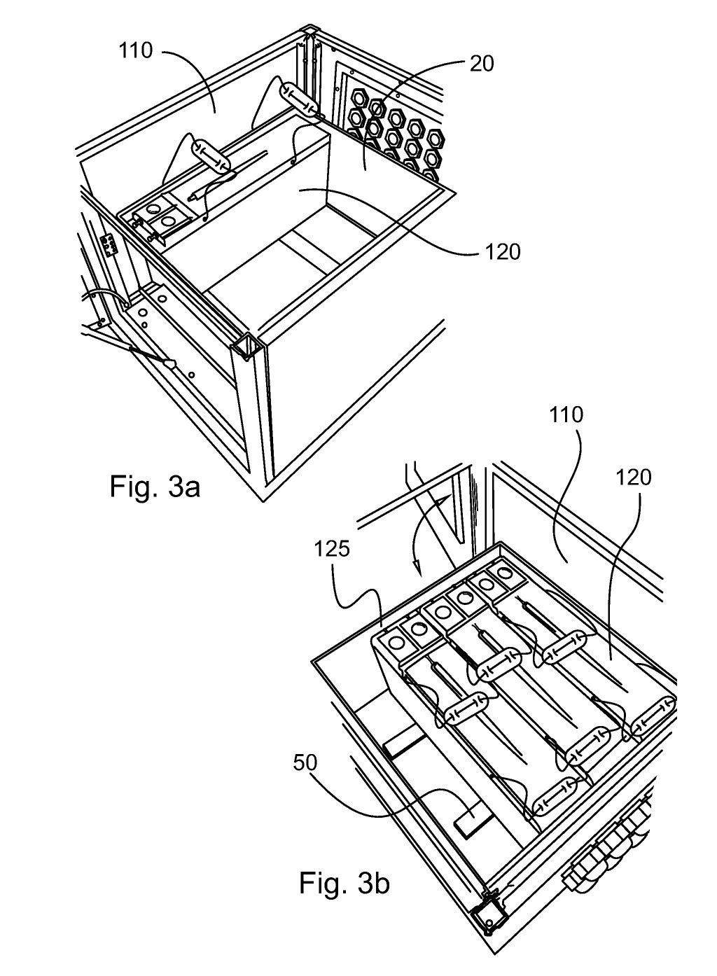

The user 180 may optionally cut the handles 85 of each one of the batteries 120 to prevent entanglement inside the metallic tray 20. See FIGS. 5a-5c.

The emission hoses 190 are connected to each battery. See FIG. 6.

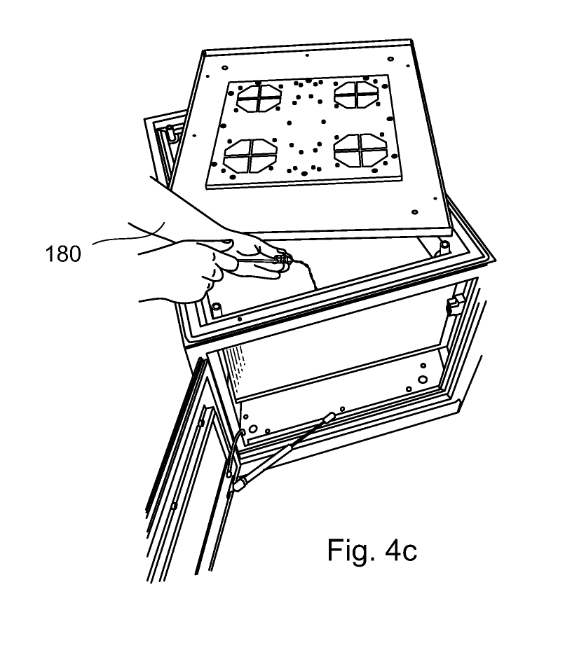

FIG. 7 shows the steps placing the covers 60 on the terminals 160 and connecting the emission hoses 190 to the terminals 160.

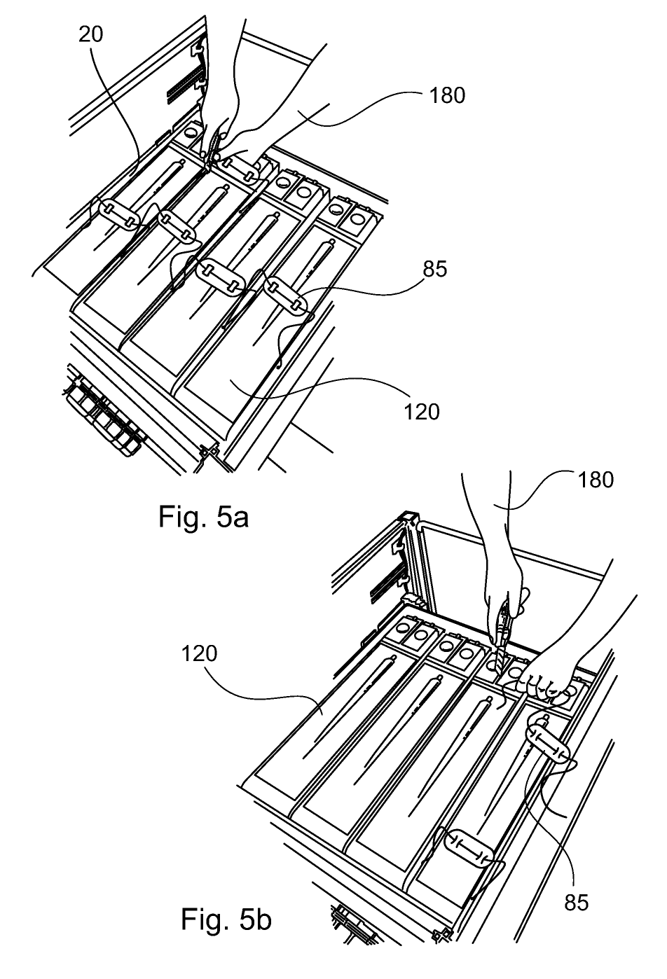

At least one metal band 70 is secured to side walls 25 of the metallic tray 20 to prevent the bending of the metallic tray and to prevent spills. See FIG. 8.

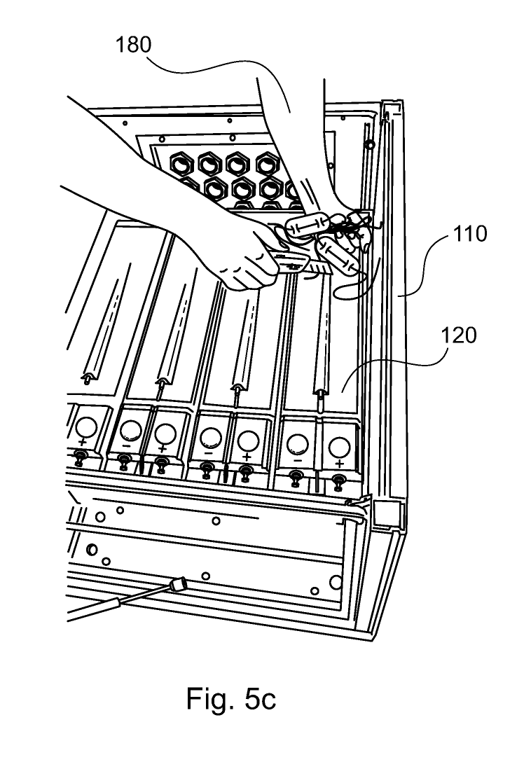

Then, a mixture containing the resin 30 and the hardening agent 40 is poured over the batteries 120 inside the metallic tray 20. The mixture is mixed on a separate container (not shown) before being poured into the metallic tray 20. See FIG. 9.

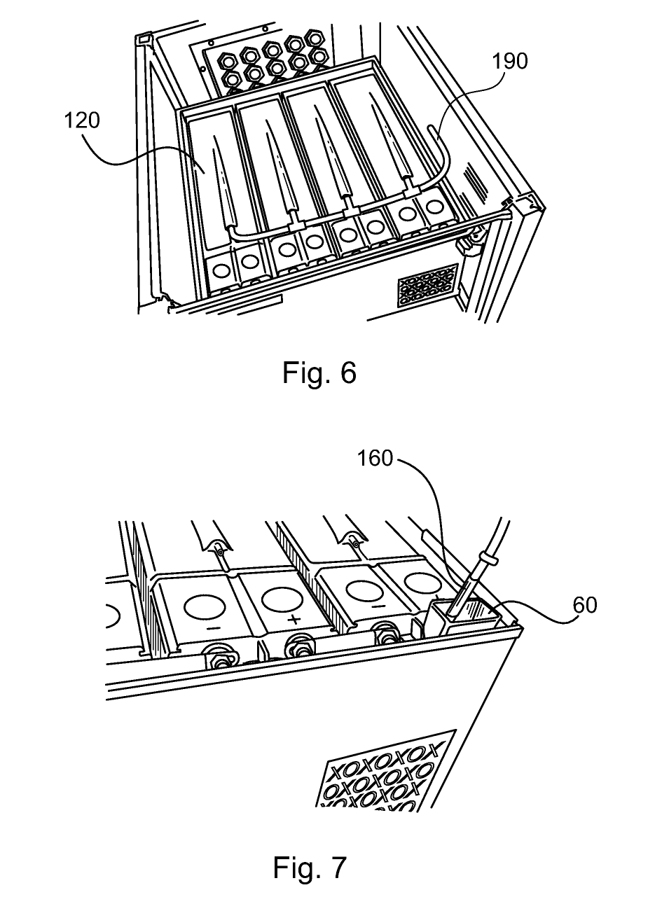

The cabinet is reassembled. See FIG. 10.

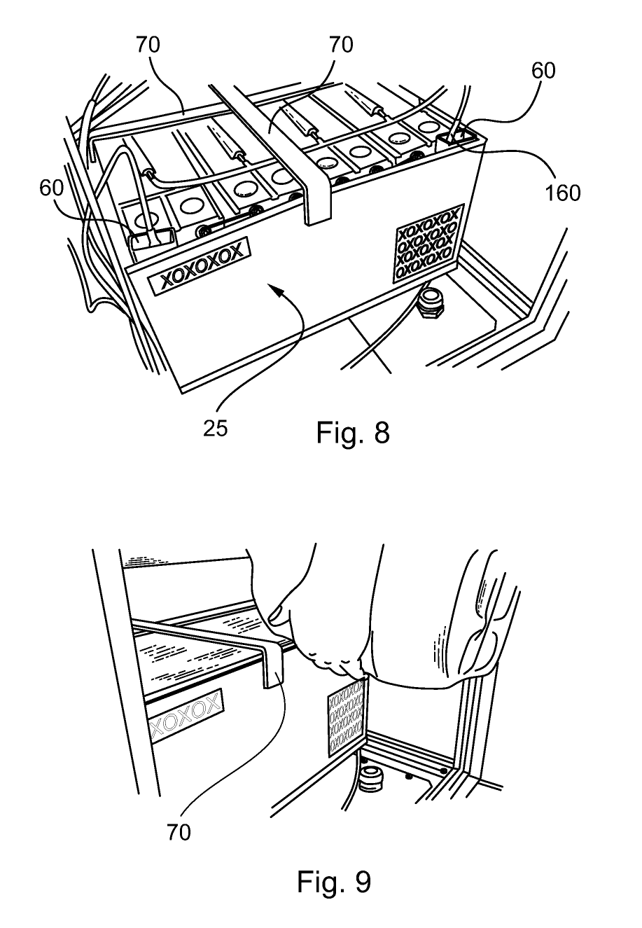

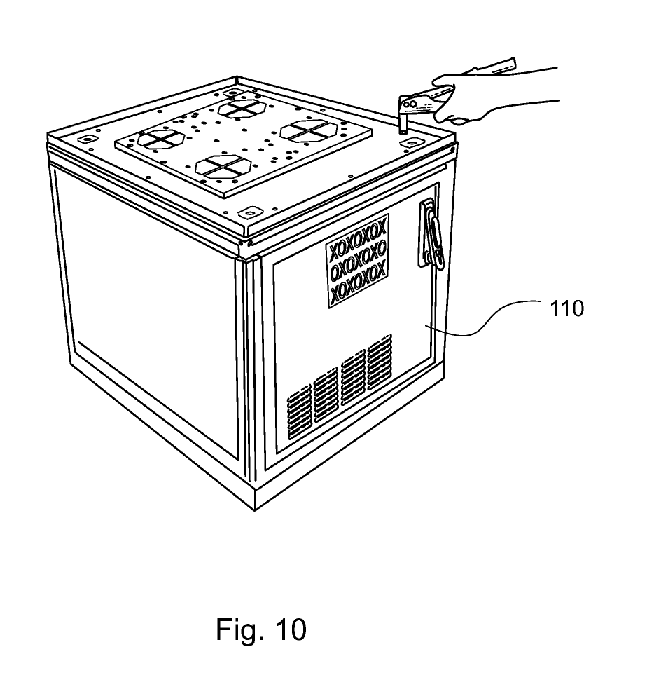

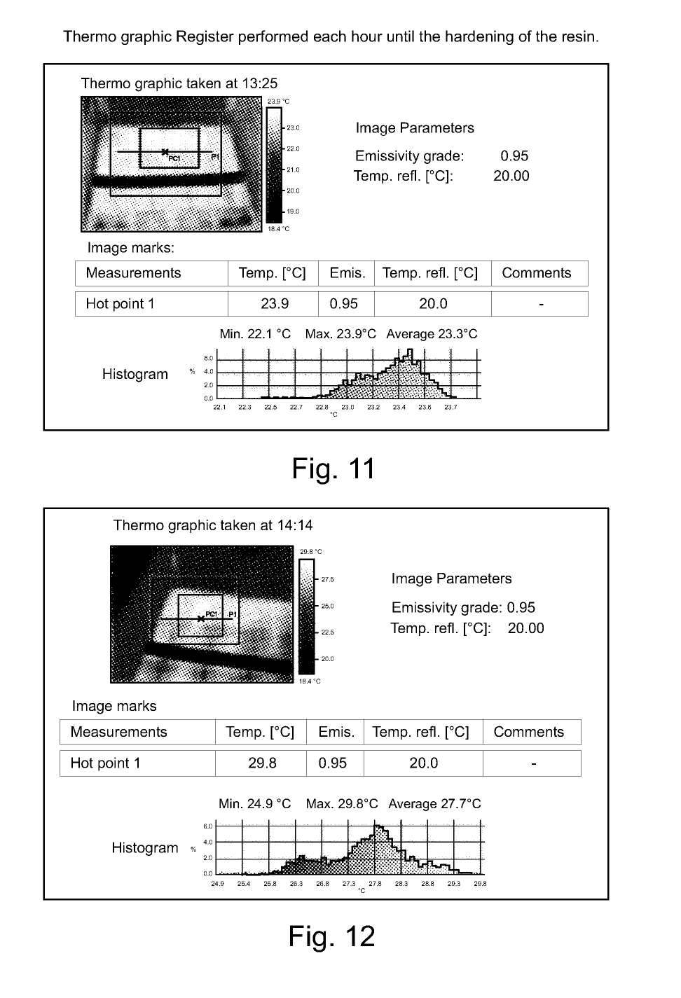

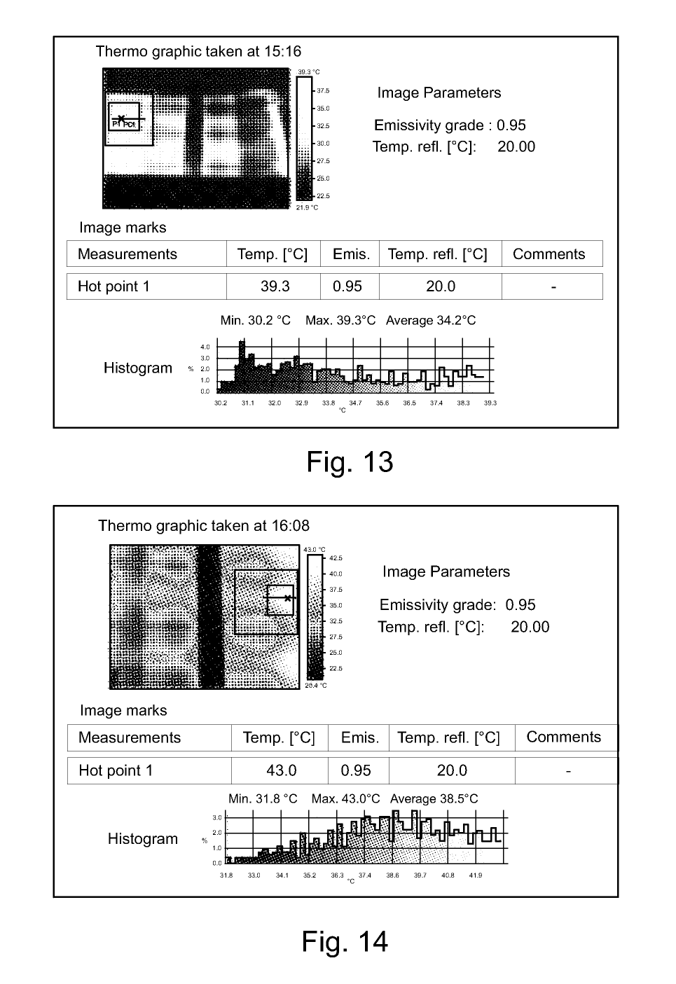

FIGS. 11-14 show graphs with the thermo graphics results of the curing of the resin taken at different times of the curing process.

The user may allow approximately 3-6 minutes for the curing of the resin and then the cabinet 100 is reassembled. See FIG. 9.

The main advantages of the batteries lock kit 10 may include:

1. Standardization in view of the different power plants.

2. Can be assembled in-situ, or not, depending on the characteristic of each one.

3. The normal voltage of the bank is 48 V (very unusual voltage, except in telephony).

4. Weight and volume is not TRANSPORTABLE by a person and it is inaccessible without specific tools.

4.1. For 92 A/H banks, the minimum weight is 120 kg.

4.2. For 155 A/H banks, the minimum weight is 225 kg.

5. Explosion proof and flame retardant.

6. The material presents a high dielectric and mechanical stiffness.

7. Thermal insulation, which helps to protect the batteries from the high temperatures.

8. The reaction is not toxic, which makes it safe for the people who handle it.

9. BATTERYLOCK is marketed in the form of a KIT, including the instructions for easy installation in charge of any operator.

This project has an objective (among the others mentioned) that is non-profitable due to the vandalism\robbery of batteries. In the first place because it is impossible to separate the pieces without breaking them and in the second place because it is too difficult to the lead extraction of the units making insignificant the economic reward for the task.

The batteries 120 do not suffer any damage when passing through the installation of the kit 10 according to the present invention.

What is claimed is:

1. A batteries lock kit to prevent an unauthorized removal of pre-existent batteries from a cabinet of a communication tower, the kit comprising:
a package container including:
a metallic tray adapted to be placed inside the cabinet;
a resin;
a hardener agent;
plastic supports;
a pair of terminal covertures;
at least one metal band; and
an emission hose;
wherein the metallic tray is adapted to support the pre-existent batteries.

2. The kit according to claim 1, further including at least one of a stirrer, a disposable bag, or a safety kit including safety glasses, gloves and a scarf.

3. The kit according to claim 1, wherein the resin is an epoxy resin.

4. The kit according to claim 3, wherein the epoxy resin is a modified biphenol A epoxy.

5. The kit according to claim 1, wherein the hardener agent is a polyethyleneamine.

6. The kit according to claim 5, wherein the polyethyleneamine is triethylenetetramine.

7. The kit according to claim 1, wherein the plastic supports are made of melamine.

8. A method for preventing an unauthorized removal of pre-existent batteries from a cabinet of a communication tower, the method comprising the steps of:
providing the kit according to claim 1;
disassembling the cabinet;
placing the metallic tray inside the disassembled cabinet, the metallic tray including side walls;
placing the pre-existing batteries of the cabinet inside the metallic tray;
placing covers on electrical terminals of the batteries;
connecting the emission hose to each one of the batteries and then to electrical terminals on the battery;
securing at least one metal band to side walls of the metallic tray;
pouring a mixture containing the resin and the hardening agent over the batteries inside the metallic tray; and
reassembling the cabinet.
